(19) United States
(12) Patent Application Publication
(10) Pub. No.: US 2025/0209475 A1
(43) Pub. Date: Jun. 26, 2025

(54) Application Programming Interface Based Monitoring of Media Exposure

(71) Applicant: The Nielsen Company (US), LLC, New York, NY (US)

(72) Inventors: Matjaz Finc, Izola (SI); Igor Sotosek, Portoroz (SI); Meryem Berrada, Beacon, NY (US); Ronny Lerch, San Antonio, FL (US); Robert Edward Taylor, Newbury, VT (US)

(21) Appl. No.: 18/612,638

(22) Filed: Mar. 21, 2024

Related U.S. Application Data
(60) Provisional application No. 63/613,094, filed on Dec. 21, 2023.

(51) Int. Cl. G06Q 30/0201; G06F 9/54

(52) U.S. Cl. CPC G06Q 30/0201; G06F 9/547

(57) ABSTRACT

Disclosed is a media-presentation device with soft-meter functionality. The media-presentation device includes a media-input interface through which to receive media for presentation, and a media-presentation interface through which to present the received media. Further, the media-presentation device includes a processor, data storage, and a meter application including program instructions stored in the data storage and executable by the processor to carry out soft-meter operations including (i) obtaining, based on calling one or more application-programming interfaces (APIs) exposed in the media-presentation device, media-presentation data regarding the presented media and (ii) providing for receipt by a cloud-based computing system a report based on the obtained media-presentation data, to facilitate establishment of ratings statistics. Further disclosed is an associated soft-meter method and non-transitory computer-readable medium having stored thereon instructions executable to provide associated soft-meter functionality in a media-presentation device.

### SUMMARY

In order to measure the extent to which people of various demographics are exposed to media content presented by media-presentation devices such as televisions, computers, tablets, phones, gaming devices, smart speakers, or other devices, a media-measurement company can arrange to have media-monitoring devices or “presentation meters” monitor media presentation in representative households or other sites. People who have their media exposure monitored may be considered “panelists,” and the places where the monitoring occurs, such as home, offices, or other premises, may be considered “panelist sites.”

At each of various panelist sites having a media-presentation device for instance, the media-measurement company may arrange for a presentation meter to monitor media presentation by that device and to generate query signature data representing the presented media. Further, the media-measurement company may also operate a computing system, such as a cloud-based computing system, to receive and evaluate this presentation-meter-generated query signature data, in order to identify the media presented at the panelist site and thereby to establish associated media-exposure data.

For instance, by evaluating an audio line feed into the media-presentation device and/or by evaluating associated acoustic speaker output, a representative presentation meter at a panelist site may be configured to detect and extract watermarked identification codes from the audio and/or to generate digital audio fingerprint data representing the audio, and to report the identification codes and/or fingerprint data, along with associated timestamps, as query signature data to the computing system for analysis. Such a presentation meter may also be configured to detect the power on or off state of the media-presentation device, so that the presentation meter can limit its media-presentation monitoring to times when the media-presentation device is on and therefore likely presenting media content being delivered to the media-presentation device.

The computing system may then be configured to refer to reference signature data that maps various identification codes and/or fingerprint data to known media content items, in order to determine, based on the presentation-meter-reported identification codes and/or fingerprint data, what media content the media-presentation device was presenting at the indicated time. In particular, the computing system may be configured to search through the reference signature data in an effort to find reference signature data that matches the reported query signature data and, upon finding a match with sufficient certainty, to conclude that media content represented by the query signature data is the media associated with the matching reference signature data, and to establish associated media-presentation records for the panelist site, thus crediting the identified media content as being presented at the panelist site (e.g., as panelist-credited content).

Further, the computing system may be configured to correlate these media-presentation records with pre-stored demographics of the panelist and/or panelist site at issue, in order to establish associated media-exposure data, and the computing system may be configured to use this media-exposure data from multiple panelist sites as a basis to establish ratings statistics that may facilitate commercial processes such as ad placement and other content delivery.

As part of establishing this media-exposure data, it may also be useful for the computing system to identify the source of the credited media content, such as the company or other entity that distributed the content in or to the panelist site for presentation. Including this information as part of the media-exposure data may enhance the data and associated ratings statistics and may facilitate useful action keyed to the source. For instance, knowledge that one or more panelist sites tend to present content received from a given content distributor may support a decision to arrange for that source to distribute particular ads and/or other content, among other possibilities.

For linear content such as broadcast feeds like a TV channel or radio station, for instance, the computing system may be able to determine the source of the content based on the identity of the linear feed itself, since particular linear feeds usually come from particular content sources. For instance, the process of matching the query signature data with reference signature data representing a particular linear broadcast channel may establish the identity of the linear broadcast channel, and the computing system may map that channel identification to a particular content distributor, such as a given cable-TV broadcaster, satellite-TV broadcaster, or terrestrial over-the air (OTA) TV broadcaster, among other possibilities.

For non-linear content such as streaming-media content provided by Over The Top (OTT) streaming-media service providers, on the other hand, at issue may be which streaming-media provider streamed the content item to the panelist site for presentation. To address this, the media-measurement company may additionally equip the panelist site with another type of meter, namely, a “streaming meter,” that is configured to monitor packet-data flow on a local area network (LAN) at the panelist site and to report to the computing system information about that packet-data flow. In practice, this streaming meter and the presentation meter could be separate devices or could be integrated together.

A representative streaming meter may be able to detect when the panelist site is receiving from an external source Internet Protocol (IP) address a packet-data flow that has a pattern of streaming (e.g., a high enough bit rate, consistent with typical media streaming), perhaps specifically when such a flow is destined to a known streaming-media player or other node on the

LAN that may output media content for presentation by the media-presentation device. The streaming meter may thus report to the computing system information such as (i) timestamps of such detected packet-data flow and (ii) the source IP address and/or other information carried in the packet-data flow that may facilitate identifying the stream source.

Given this or other such information reported by a streaming meter at the panelist site, the computing system may thereby be able to determine the source of non-linear content presented at the panelist site at a given time. For instance, provided with query signature data representing content presented at the panelist site at a given time, the computing system may correlate timestamps of that query signature data with timestamps of detected packet-data flow into the panelist site LAN, and the computing system may correlate the reported source-IP address or other such information in the packet-data flow with a particular streaming-media provider. The computing system may thereby conclude that the content presented at that time was provided by that particular streaming-media provider.

In typical implementations, these presentation and streaming meters are hardware devices that would be physically connected to one or more other devices at the panelist site to facilitate monitoring media exposure.

For instance, to monitor the on/off state of a television or other media-presentation device, the presentation meter may be physically connected as an intermediary in a path of power-supply to the media-presentation device if applicable, so that the presentation meter can monitor electronic characteristics on that path, to determine when the media-presentation device is powered on and to limit the meter's monitoring accordingly. Further, to monitor media presentation by the television or other media-presentation device, the presentation meter could be connected as an intermediary in the media-delivery path between one or more media sources and the media-presentation device if applicable, and the presentation meter could monitor media flowing on that path, and/or the meter could include one or more microphones and/or cameras configured to receive audio and/or video output presented by the media-presentation device and/or associated systems and could monitor that received audio and/or video. In addition, to monitor the flow of traffic on the panelist-site LAN, the streaming meter may be physically connected as a node sitting on the panelist site LAN.

Unfortunately, however, there are significant costs and burdens associated with use of a physical hardware meter for monitoring media exposure. For one, there are costs associated with manufacturing the meter device itself and with maintaining and supporting the operation of that device. Further, implementing physical meter devices at panelist sites may burden panelists who may need to arrange for and/or engage in meter installation and may need to manage the presence and upkeep of the physical meter device at their sites, among other issues.

The present disclosure provides an improvement that may help to address these and other issues, by leveraging the computing infrastructure and network-connected nature of many modern media-presentation devices themselves. In particular, the disclosure provides for a media-presentation device to be configured to itself monitor and report media-presentation data (also referred to as media-exposure data), making use of one or more application programming interfaces (APIs) exposed in the media-presentation device, to elicit media-presentation information, and reporting associated information for receipt and evaluation by a cloud-based computing system.

Accordingly, in one respect, disclosed is a media-presentation device with soft-meter functionality. The media-presentation device includes a media-input interface through which to receive media for presentation by the media-presentation device, and a media-presentation interface through which to present the received media. Further, the media-presentation device includes a processor, non-transitory data storage, and a meter application including program instructions stored in the non-transitory data storage and executable by the processor to carry out soft-meter operations. In an example implementation, the soft-meter operations include (i) obtaining, based on calling one or more APIs exposed in the media-presentation device, media-presentation data regarding the presented media and (ii) providing for receipt by a cloud-based computing system a report based on the obtained media-presentation data, to facilitate establishment of ratings statistics.

In another respect, disclosed is a method for soft-metering by a media-presentation device, where the media-presentation device includes a media-input interface through which to receive media for presentation by the media-presentation device, and a media-presentation interface through which to present the received media. The method includes (i) the media-presentation device obtaining, based on calling one or more APIs exposed in the media-presentation device, media-presentation data regarding the presented media, and (ii) the media-presentation device providing, for receipt by a cloud-based computing system, a report based on the obtained media-presentation data, to facilitate establishment of ratings statistics.

In yet another respect, disclosed is a non-transitory computer-readable medium having stored thereon a meter application defining program instructions executable by a processing unit of a media-presentation device to carry out soft-meter operations, where the media-presentation device includes a media-input interface through which to receive media for presentation by the media-presentation device, and a media-presentation interface through which to present the received media. The soft-meter operations include (i) obtaining, based on calling one or more APIs exposed in the media-presentation device, media-presentation data regarding the presented media, and (ii) providing for receipt by a cloud-based computing system a report based on the obtained media-presentation data, to facilitate establishment of ratings statistics.

These as well as other aspects, advantages, and alternatives, will become apparent to those of ordinary skill in the art by reading the following detailed description, with reference where appropriate to the accompanying drawings. Further, it should be understood that the disclosure provided in this summary elsewhere in this document is provided by way of example only and that numerous variations and other examples may be possible as well.

### BRIEF DESCRIPTION OF THE DRAWINGS

FIG. 1 is a simplified block diagram of an example media-presentation device.

FIG. 2 is a flow chart illustrating an example method.

### DETAILED DESCRIPTION

The present disclosure will discuss example implementation in relation to a smart television (TV), which may be an internet-connected TV that supports free and/or paid streaming-media applications such as applications for the OTT services noted above. It will be understood, however, that the disclosed principles could apply as well in connection with other types of media-presentation devices, including other types of televisions and non-television devices. Further, while the disclosure provides for a media-presentation device being configured to engage in these operations, some implementations may involve a separate device, such as a presentation meter and/or streaming meter for instance, being configured to engage in certain operations.

More generally, it will be understood that arrangements and processes disclosed herein could take various other forms. For instance, elements and operations could be re-ordered, distributed, replicated, combined, omitted, added, or otherwise modified. In addition, elements described as functional entities could be implemented as discrete or distributed components or in conjunction with other components/modules, and in any suitable combination and location. Further, various operations described as being carried out by one or more entities could be implemented by and/or on behalf of those entities, through hardware, firmware, and/or software, such as by one or more processing units executing program instructions stored in memory, among other possibilities.

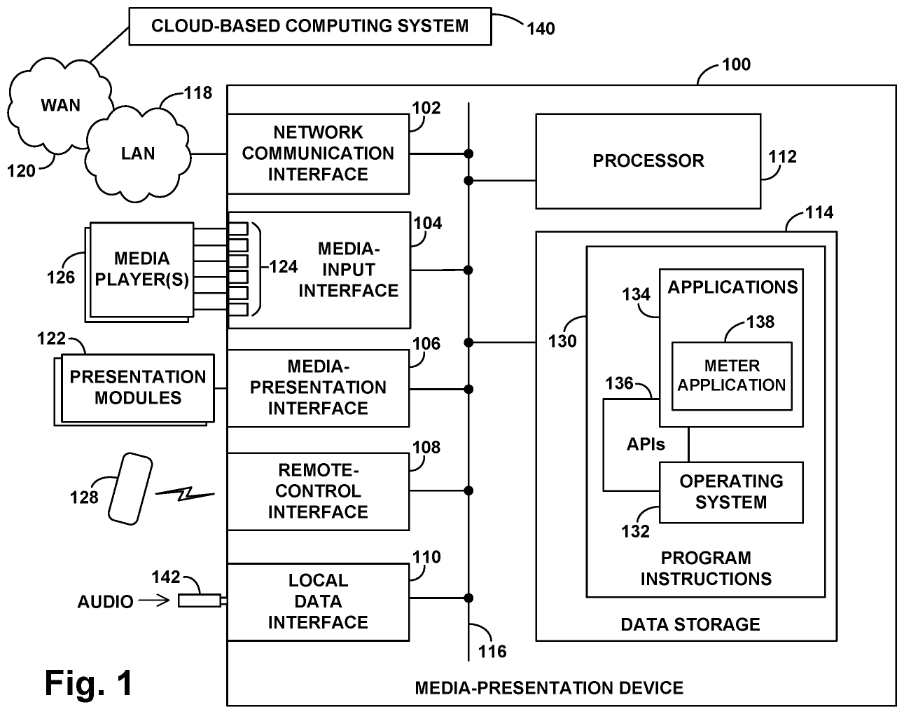

Referring to the drawings, FIG. 1 is a simplified block diagram of an example media-presentation device 100, such as a smart TV for instance. As shown in FIG. 1, the example media-presentation device 100 includes a network communication interface 102, a media-input interface 104, a media presentation interface 106, a remote-control interface 108, a local data interface 110, a processor 112, and non-transitory data storage 114, all of which may be communicatively linked together by a system bus and/or one or more other connection mechanisms 116.

While these components are illustrated separately, they may be combined together in various ways. For instance, the network communication interface 102 and media-input interface 104 and could be integrated together at least to some extent for receiving media input and facilitating other network communications over a common network. Other examples are possible as well.

In the example device, the network communication interface 102 could facilitate communication on a network such as packet-switched LAN 118, which may in turn facilitate communication on a wide area network (WAN) 120 such as the internet. As such, the network communication interface 102 could comprise one or more wired Ethernet network interface modules and/or one or more wireless network interface modules such Wi-Fi modules, which could be served by a LAN router and modem and/or other network infrastructure for providing WAN connectivity.

The media-input interface 104 could facilitate receiving media, such as audio and video media, for presentation by the media-presentation device. As such, the media-input interface 104 could comprise one or more input modules 124, which could take various forms. For instance, the input modules 124 could include one or more High Definition Multimedia Interface (HDMI) ports through which to receive respective media feeds from local media players 126 such as a cable-TV set top box, an OTT player, and/or an audio/video receiver. Further, the input modules 124 could include a coaxial-cable port through which to receive a respective media feed from an over-the-air terrestrial media broadcaster. Still further, the input modules 124 could include or interwork with the network communication interface 102 to receive broadband media feeds such as OTT streams, among other possibilities.

The media-presentation interface 106 could facilitate presentation of received media, possibly in real-time as the media-presentation device 100 receives the media. As such, the media-presentation interface could comprise one or more presentation modules 122, which could also take various forms. For instance, the presentation modules 122 could include one or more sound speakers for acoustically outputting the received audio and/or one or more wired or wireless audio output interfaces for conveying received audio to one or more other speakers, headphones, sound-bars, and/or other audio presentation mechanisms for acoustic playout. Further, the presentation modules 122 could include a display panel, such as a liquid crystal display (LCD), a light emitting diode (LED) display, or an organic LED (OLED) display, for presenting received video content in correspondence with received audio content for instance.

The remote-control interface 108 could facilitate communication and interaction with an external remote control 128 that is configured to control operations of the media-presentation device 100. The remote control 128 could take various forms, such as a dedicated handheld remote control configured to control the media-presentation device 100, and/or a smart phone, smart watch, computer, or other personal communication and/or computing device configured to control the media-presentation device 100. The remote-control interface 108 may comprise a wireless communication interface through which the remote control 128 could send control commands to the media-presentation device 100, and through which the remote control 128 could receive operational status information from the media-presentation device 100. The remote control 128 may further include a display or other mechanism for presenting this operational status information.

The local data interface 110 could facilitate data communication with locally connected devices. The local data interface 110 could take various forms, including without limitation one or more wired interfaces such as a Universal Serial Bus (USB) interface and/or one or more wireless interfaces such as Bluetooth, Wi-Fi, or Zigbee interfaces.

The processor 112 comprises one or more processors, such as one or more general purposes processors (e.g., microprocessors) and/or one or more special purpose processors (e.g., digital signal processors). Further, the non-transitory data storage 114 comprises one or more volatile and/or non-volatile storage components (e.g., flash, optical, magnetic, ROM, RAM, EPROM, EEPROM, etc.), and may be integrated in whole or in part with the processor 112.

The non-transitory data storage 114 could then store program instructions 130, which could be executable by the processor 112 to carry out various media-presentation-device operations, including those described herein. Some of these program instructions could be loaded into the non-transitory data storage 114 at the time of manufacture of the media-presentation device 100 and/or later as an update of the device. Further, some program instructions may be hard coded in the media-presentation device 100.

As shown, the program instructions 130 in the example media-presentation device define an operating system 132 and applications 134. The operating system 132 may generally manage hardware of the media-presentation device 100 and provide common services and interfaces for various applications 134, acting as an intermediary between the hardware and the applications for instance. The applications 134 may then run on the operating system 132 and be configured to perform specific tasks. Examples of the applications 134 include, without limitation, OTT applications configured to access specific OTT services in order to receive OTT streaming media for presentation by the media-presentation device 100, and utility applications of various sorts.

As further shown, the program instructions 130 define one or more APIs 136, which may establish rules, protocols, and tools to enable software systems, hardware, services, and/or other modules to communicate and interact with each other. Some of these APIs 136 could be established by program instructions that are part of the operating system 132, and some of these APIs 136 could be established by program instructions that are part of particular applications 134. As these APIs are defined by program instructions executable in the media-presentation device 100, the APIs are considered to be exposed in and by the media-presentation device 100. Namely, the APIs define programmatic hooks within the media-presentation device 100 that other program logic in the media-presentation device 100 could use or “call” as a basis to trigger action, request and obtain information, and/or to carry out other useful functions.

In line with the discussion above, one of the applications 134 in the media-presentation device could be a meter application 138 that includes program instructions executable by the processor 112 to cause the media-presentation device 100 to monitor and report media-presentation data. (The act of the processor 112 executing the meter application 138 to cause the media-presentation device 100 to carry out various operations may be referred to for simplicity as the meter application 138 carrying out the operations.)

In particular, just as the media-presentation device 100 may be programmed with and run individual applications respectively to provide individual OTT streaming-media services or the like, the media-presentation device 100 may also be programmed with a meter application that is executable by a processor of the media-presentation device 100 to cause the media-presentation device 100 to engage in one or more monitoring functions in order to establish media-presentation data and to report associated information to a cloud-based computing system 140 for evaluation. To facilitate this, the meter application 138 could be provisioned with a network address (e.g., Uniform Resource Locator) of the cloud-based computing system 140 to which the meter application 138 could direct such reports.

Optimally, the meter application 138 may make use of one or more of the APIs 136 that are exposed in the media-presentation device 100. Optimally, these APIs may allow the meter application 138 to make use of information that may otherwise be accessible for other purposes in the media-presentation device 100. Namely, the meter application 138 may conveniently leverage the APIs, making the information exposed by the APIS, or associated or statistically rolled-up information available for use by the cloud-based computing system 140 for media-exposure monitoring such as to facilitate establishing of ratings statistics.

Some of the APIs that the meter application 138 could use for this purpose may be specific to media-presentation device 100 such as by being defined by the operating system 132 of the media-presentation device 100, and some of the APIs that the meter application 138 uses for this purpose may be provided by one or more other applications 134 installed on the media-presentation device 100. By executing the meter application 138, the processor 112 of the media-presentation device 100 may interact with these APIs to obtain useful information related to media presentation by the media-presentation device. This could include, without limitation, broadcast-communication information, diagnostic information (e.g., usability information), and other content and metadata related information.

Example APIs that the meter application 138 could use as a basis to obtain media-presentation data in order to facilitate providing a report for receipt by the cloud-based computing system 140 may include (i) an operating-system API, i.e., an API provided by the operating system 132 of the media-presentation device 100, (ii) a remote-control API, and (iii) an accessibility API, as well as any combinations of these or other APIs. (In one implementation, for instance, an operating-system API may itself include a remote-control API and/or an accessibility API, among others.)

By way of example, the media-presentation device 100 may be programmed with a remote-control API that is configured to enable the media-presentation device 100 to interact with a remote control 128 as noted above, such as dedicated handheld remote control or a remote-control application running on a mobile phone for instance. This remote control 128 may interact with the remote-control API on the media-presentation device 100, through the remote-control interface 108 or another physical-layer connection with the media-presentation device 100. Over this physical-layer connection, for instance, the remote control 128 may call the remote-control API, sending remote-control commands and/or queries for information, and the remote control 128 may receive in response from the media-presentation device 100 various information such as status and identification of media being presented by the media-presentation device 100, e.g., content channel being presented, OTT streaming-media application being used to receive the media being presented, etc. The remote control 128 may then be able to present some or all of this information, or associated indicia, for a user of the remote control to see.

In an example implementation, the meter application 138 running on the media-presentation device 100 itself may be executable by the processor 112 of the media-presentation device 100 to make one or more calls to this remote-control API in order to obtain useful media-monitoring information, such as (i) identification of media being presented, (ii) identification of channel being presented, (ii) identification of content source, such as which OTT application is providing the content and/or which media-input source 124, or associated source device (e.g., as indicated by HDMI data, such as a Extended Display Identification Data (EDID)) is currently providing the media being presented by the media-presentation device 100, etc., (iii) the on/off state of the media-presentation device 100, and (iv) volume of playout by the media-presentation device 100, etc. The meter application 138 may then roll up this information possibly along with other information, e.g., as timestamped media-monitoring data, and report the information over a network connection to the cloud-based computing system 140.

Having the meter application 138 that is running on the media-presentation device 100 interact with this remote-control API on the media-presentation device 100 in order to obtain media-monitoring-related information for reporting to the cloud-based computing system 140 is a technical advance over having a remote control separate from the media-presentation device 100 interact with the remote-control API for purposes of traditional control-interaction with the media-presentation device 100 (e.g., to control traditional operation of the media-presentation device 100).

Namely, while the remote-control API may be present in the media-presentation device 100 to support interaction between the TV and an external remote control 128, the meter application 138 that runs on the media-presentation device 100 may take advantage of the remote-control API to obtain useful media-monitoring-related information for reporting to the cloud-based computing system 140. The meter application 138 can thus leverage the information exposed by the remote-control API, even though the meter application 138 is within the media-presentation device 100 rather than in the external remote-control device.

(Note also that, in another arrangement, an external presentation-meter and/or streaming-meter device may usefully leverage a remote-control API of the media-presentation device, to gather media-exposure data that the meter device could then report to the cloud-based computing system for evaluation. In particular, as an enhancement to the meter-device operations discussed above, such a meter device could be programmed to function in a manner similar to how a remote-control application on a mobile phone might function, in order to gather and report useful media-exposure data. For instance, just as a remote-control application running on mobile phone may send remote-control API calls over the LAN to the media-presentation device and responsively receive from the media-presentation device useful media-monitoring-related information (such as but not limited to status and identification of media being presented), application logic running in the external meter device may be configured to send remote-control API calls over the LAN to the media-presentation device and responsively receive such media-monitoring-related information, and the meter device may be configured to report that information to the cloud-based computing system for evaluation.)

As another example, an operating system API of the media-presentation device 100 may define one or more API calls that facilitate on-screen interactions, such as presentation on a display panel of the media-presentation device 100 of various overlay prompts, and receiving user responses to the presented prompts (e.g., from the user engaging in touch-screen or remote-control interaction, etc.) The meter application 138 may usefully interact with this operating system API to facilitate identifying who is at the media-presentation device 100 when the media-presentation device 100 is presenting media, and thus who is exposed to the presented media, as a form of active user login to help enhance media-exposure data, and the meter application 138 could report this information to the cloud-based computing system 140.

For instance, the meter application may periodically and/or in response to one or more other triggers interact with this operating system API to cause the media-presentation device 100 to present on a display panel of the media-presentation device 100 a prompt such as “Please select which of the following individuals is currently watching”, providing options for each of various individuals who may be pre-registered as panelists in association with the meter application 138 for instance. Through use of a connected remote control 128, a user may then respond to this on-screen prompt, thereby informing the meter application 138 who is consuming the media being presented by the media-presentation device 100. And the meter application can usefully report this person-level data to the cloud-based computing system 140, to enhance media-exposure monitoring.

As still another example, an operating system API of the media-presentation device 100 may define one or more API calls configured to provide access to the audio and/or video content presented by the media-presentation device 100. In that case, the meter application 138 may interact with the operating system API to obtain the audio and/or video being presented, and the meter application 138 may extract watermark data from that media and/or generate digital fingerprint data representing that media, which the meter application 138 may then send to the cloud-based computing system 140 for evaluation.

This operating system API may provide access to the media as it is being processed for presentation within the media-presentation device 100. Alternatively, in a scenario where this API does not provide access to the media being processed for presentation, another implementation could involve the API providing access to audio from a simple connected microphone device 142. Among other possibilities, this simple microphone device 142 may take the form of a USB dongle containing a microphone for receiving acoustic audio and for providing a digital representation of the received audio.

Such a microphone device 142 could be connected to the local data interface 110 of the media-presentation device 100, which may also provide power to drive the microphone device 142. When the media-presentation device 100 is presenting media that includes audio, the connected microphone device 142 could then receive and digitize that audio as output from the media-presentation device 100 (e.g., from an internal or connected speaker). Further, through its local-data-interface connection with the media-presentation device 100, the microphone device 142 could provide the digitized audio (possibly converted in form) to the meter application 138 (i.e., to the internal processor 112 running the meter application 138) for analysis.

Thus, as the media-presentation device 100 is presenting media, the meter application 138 could receive the digitized audio of that media as provided by the connected microphone device 142, and the meter application 138 could establish signature data, such as extracting watermark data or generating fingerprint data, from that audio data, and could report the established signature data to the cloud-based computing system 140 for evaluation.

As another example, possibly aside from any remote-control API, the operating system API of the media-presentation device 100 may expose the identity of which of various OTT applications on the media-presentation device 100 is currently running and providing content for presentation by the media-presentation device 100. The meter application 138 may thus interact with this API to identity the OTT application that is currently providing content being presented by the media-presentation device 100, and the meter application 138 may report this information to the cloud-based computing system 140 as well.

Likewise, the operating system API of the media-presentation device 100 may expose the identity of which of various media-input modules 124 is currently an active source providing the media that is being presented by the media-presentation device 100. Further, the operating system 130 may not only have information indicating which media-input module 124 is currently set as the active source, but may also have information indicating what source device is connected to that media-input module 124 (e.g., whether a cable-TV set top box, an OTT media player, an Blue-ray player, or another device), possibly as indicated by signaling through the media-input module 124, such as Extended Display Identification Data (EDID) carried by HDMI signaling for instance. The operating system API of the media-presentation device 100 may thus expose this information. And the meter application 138 may thus interact with this API to get this information regarding the media currently being presented and may report this information to the cloud-based computing system 140 as well.

As yet another example, the media-presentation device 100 may be programmed with an accessibility API that may serve needs of hearing-disabled people or the like. This accessibility API may exist in the media-presentation device to enable OTT applications or the like running on the media-presentation device 100 to get information about the presented media (e.g., channel information, etc.), in order to facilitate presenting the information on a display or other assistance device. Thus, one or more other applications running on the media-presentation device 100 may make use of this API to obtain information about the presented media and may present or arrange for presentation of that obtained information for accessibility purposes. The meter application 138 may usefully take advantage of this accessibility API in order to get information for media-exposure monitoring. For instance, the meter application 138 may call the accessibility API to get information such as an identification of a channel being presented, an identification of an OTT application or media source providing the media, etc., without providing this information for accessibility use. The meter application 138 may report the obtained information to the cloud-based computing system 140 for evaluation as well.

As another example, through interaction with an operating system API or other API of the media-presentation device 100, the meter application 138 may obtain closed-caption text or associated data being presented on a display screen of the media-presentation device 100, and the meter application may then report this information or associated information to the cloud-based computing system 140. In an example implementation, such an API may be configured to manage closed-caption-text presentation by the media-presentation device, based on closed-caption text received for presentation and/or closed-caption text generated in real time, among other possibilities. The meter application 138 may thus leverage the API to gain access to the closed-caption text, for reporting to the cloud-based computing system 140. Optimally, sequences of closed-caption text may indicate what content is being presented, and so the cloud-based computing system 140 may be able to evaluate the reported close-caption text as a basis to determine what content the media-presentation device 100 was presenting, in turn as a basis to credit for presented content.

As still another example, the media-presentation device 100 may include a LAN API (also likely part of the operating system 130) that enables communication, through the network communication interface 102, on the LAN 118, which may be a LAN of a panelist site. The meter application 138 running on the media-presentation device 100 may make use of this LAN API not only as a basis to engage in communication on the LAN 118 and beyond (e.g., to facilitate reporting to the cloud-based computing system 140), but also as a basis to identify other media-monitoring-related devices present on the panelist's LAN. For instance, through this LAN API, the meter application may broadcast onto the LAN 118 a Simple Service Discovery Protocol (SSDP) message or other such discovery request, to discover network services supported on the LAN 118, and may receiver information indicating the presence on the LAN 118 of other devices such as other media-presentation devices, OTT players, set top boxes, etc.

Assuming proper permissions, the meter application 138 may then report this information to the cloud-based computing system 140, to facilitate other related media-exposure monitoring. For instance, this data may enable the cloud-based computing system 140 to keep an up-to-date mapping of media-monitoring-related devices at the panelist site, which may help avoid the need for panelists to manually report when they add new devices to their site.

As yet another example, through interaction with an operating system API of the media-presentation device 100, a remote-control API of the media-presentation device 100, and/or the like, the meter application 138 may determine when an output volume level of the media-presentation device 100 changes and may report associated information to the cloud-based computing system 140. For instance, the meter application 138 may call such an API to subscribe to receive notifications when the output volume level of the media-presentation device 100 changes and indications of the output volume level over time and may therefore receive notifications accordingly.

This volume information may usefully help indicate whether one or more individuals are consuming the media content presented by the media-presentation device 100. For instance, if and when the volume level is particularly low, that may indicate that no one is consuming the content presented by the media-presentation device 100, in which case the cloud-based computing system 140 may responsively not credit presented content as being consumed by any individuals at the panelist site. Whereas, if and when the volume level is high enough, that may indicate that someone is consuming the content presented by the media-presentation device 100, in which case the cloud-based computing system 140 may responsively credit presented content as being consumed by one or more individuals at the panelist site.

Analysis of this volume level in relation to active or passive user login indicating presence at the media-presentation device 100 may also be used as a basis to train a machine learning model to predict the quantity and/or identity of individuals present at the media-presentation device 100 in association with particular volume levels. The meter application 138 and/or cloud-based computing system 140 may then use this trained machine-learning model to predict this quantity or identification information based on detected volume information, which could be used as a further basis to enhance media-monitoring evaluation.

As still another example, through interaction with an operating system API of the media-presentation device 100, a remote-control API of the media-presentation device 100, and/or the like, the meter application 138 may determine when the media-presentation device 100 is muted, i.e., when its volume is set to mute and thus silent but while the media-presentation device 100 continues to present video content. For instance, the meter application 138 may call such an API to subscribe to be notified when the media-presentation device 100 enters the mute state (and likewise when the media-presentation device 100 exits the mute state) and may therefore receive notification accordingly.

Normally when a media-presentation device such as media-presentation device 100 is in a mute state, an external meter may detect no audio output and may therefore not extract any audio watermark data, and so the computing system would not credit presented content as being watched at the panelist site.

When the meter application 138 determines that the media-presentation device 100 is in the mute state, the meter application 138 may usefully respond to that determination by then taking action to help identify the content being presented. For instance, in response to thereby learning that the media-presentation device 100 is in the mute state meter application may responsively call an operating system API of the media-presentation device 100 to obtain closed-caption data and/or source data, which may indicate what channel or other content is being presented, and/or the meter application may responsively obtain an internal audio feed if it is not doing so already and extract watermark data. The meter application may then likewise send this obtained media-presentation data to the cloud-based computing system 140, to facilitate crediting content even though the media-presentation device 100 was muted at the time of media presentation.

The meter application 138 running on and executed by the processor of the media-presentation device 100 could also be configured to interact with numerous other APIs exposed in the media-presentation device 100 in order to establish other useful information that the meter application can report to the cloud-based computing system for media-exposure monitoring.

Without limitation, for example, the meter application 138 could be configured to interact with a face-recognition API in the media-presentation device 100 to get identifying information about individuals present in front of the media-presentation device 100 when content is being presented and to report that identifying information to the cloud-based computing system 140 for evaluation. As another example, the meter application 138 could be configured to interact with an API to access a database or other data storage on the media-presentation device 100 to obtain previously determined media-exposure related information for reporting to the cloud-based computing system 140 for evaluation.

As yet another example, the meter application 138 could be configured to interact with one or more APIs on the media-presentation device 100 to obtain information about content presented in a picture-in-picture mode and/or on an associated second-screen device and to report that information to the cloud-based computing system for evaluation. And as still another example, the meter application could be configured to interact with one or more APIs on the media-presentation device 100 to obtain identifying information about a local device such as a smart phone or tablet that is casting or slinging content being presented by the media-presentation device 100 and to report that information to the cloud-based computing system 140 for evaluation.

Accordingly, as noted above, an example implementation could take the form of a media-presentation device configured with soft-meter functionality. The media-presentation device could comprise a media-input interface through which to receive media for presentation by the media-presentation device, a media-presentation interface through which to present the received media, a processor, and non-transitory data storage. Further, the media-presentation device could comprise a meter application that includes program instructions stored in the non-transitory data storage and executable by the processor to carry out soft-meter operations including (i) obtaining, based on calling one or more APIs exposed in the media-presentation device, media-presentation data regarding the presented media and (ii) providing for receipt by a cloud-based computing system a report based on the obtained media-presentation data, to facilitate establishment of ratings statistics.

In line with the discussion above, the media-presentation data that the meter application obtains could include identification of the presented media, identification of a channel of the presented media, identification of a source of the presented media, audio volume of presentation of the media, and user identification information indicating one or more individuals exposed to the presented media.

Further, as discussed above, the media-presentation device could be controllable by an external remote control, and the one or more APIs exposed in the media-presentation device could include a remote-control API configured to enable the media-presentation device to provide the external remote control with information about the presented media. The act of obtaining the media-presentation data based on calling the one or more APIs exposed in the media-presentation device could then involve calling the remote-control API to obtain, as at least a portion of the media-presentation data, the information about the presented media.

In addition, as discussed above, the one or more APIs exposed in the media-presentation device could include an operating system API configured to support user interaction through the media-presentation interface. The act of obtaining the media-presentation data based on calling the one or more APIs exposed in the media-presentation device could then involve obtaining, as at least part of the media-presentation data, the user identification information by calling the operating system API to cause the media-presentation device (i) to present through the media-output interface a prompt requesting user input indicating who is exposed to the presented media and (ii) to receive in response to the presented prompt the user input indicating who is exposed to the presented media.

As further discussed above, the one or more APIs exposed in the media-presentation device could include an operating system API configured to provide information indicating which of OTT applications installed on the media-presentation device is currently running and providing content for presentation by the media-presentation device. The act of obtaining the media-presentation data based on calling one or more APIs exposed in the media-presentation device could then involve calling the operating system API to obtain, as at least part of the media-presentation data, an indication of which of the OTT applications, if any, is currently running and providing content for presentation by the media-presentation device.

Still further, as discussed above, the media-input interface of the media-presentation device could include multiple media-input sources, and the one or more APIs exposed in the media-presentation device could include an operating system API configured to provide an identification of which media-input source is currently in use (which may be or include an identification of a source device or service connected to the active media-input source for instance). The act of obtaining the media-presentation data based on calling the one or more APIs exposed in the media-presentation device could then involve calling the operating system API to obtain, as at least part of the media-presentation data, an indication of which media-input source is currently in use as a source of the presented media (e.g., an identification of the source device or service).

Yet further, as discussed above, the one or more APIs exposed in the media-presentation device could include an operating system API configured to provide closed-caption text for presentation with the media. The act of obtaining the media-presentation data based on calling the one or more APIs exposed in the media-presentation device could then involve calling the operating system API to obtain, as at least part of the media-presentation data, the closed-caption text.

In addition, as discussed above, the one or more APIs exposed in the media-presentation device could include an operating system API configured to provide information about audio-output volume level of the media-presentation device. The act of obtaining the media-presentation data based on calling the one or more APIs exposed in the media-presentation device could then involve calling the operating system API to obtain, as at least part of the media-presentation data, the information about the audio-output volume level of the media-presentation device. This or another such API call, for instance, may obtain information about the media-presentation device being in a mute state in which the audio-output volume level is zero, which, as noted above, may usefully allow crediting content even for a time when there is no audio output.

As further discussed above, the one or more APIs exposed in the media-presentation device could include a media-access API configured to provide access to the presented media. The act of obtaining the media-presentation data based on calling the one or more

APIs exposed in the media-presentation device could then involve (a) calling the media-access

API to obtain audio of the presented media and (b) establishing based on the obtained audio, as at least part of the media presentation data, audio signature data representing the presented media.

In addition, as discussed above, the media-presentation device could include a local data interface, and a microphone-device coupled with the local data interface could receive acoustic audio output from a speaker of the media-presentation device and provide to the local data interface a digital representation of the received acoustic audio. The act of obtaining the audio of the presented media could then involve obtaining that digital representation of the received acoustic audio.

Yet further, as discussed above, the media-presentation device could be connectable with a LAN, e.g., by a network communication interface that may function as at least part of the media-input interface. The meter application may then also be executable by the processor (a) to broadcast on the LAN a discovery request seeking identification of one or more media-monitoring devices present on the LAN, (b) to obtain, in response to the broadcast, the identification of the one or more media-monitoring devices present on the LAN, and (c) to report for receipt by the cloud-based computing system the obtained identification of the one or more media-monitoring devices present on the LAN. Examples of such media-monitoring devices may include one or more other media-presentation devices, media players, or meters, among other possibilities.

In an example implementation, a media-presentation device may thus be configured to carry out operations described herein, leveraging one or more APIs exposed in the media-presentation device to obtain media exposure data and reporting accordingly to a cloud-based computing system or external other computing system. In another example implementation, a media-presentation device and an external computing system may work together to carry out operations described, such as by the media-presentation device using one or more such exposed APIs to obtain media exposure data and reporting information accordingly to the computing system, and the computing system using the reported information as a basis to establish media-exposure data, ratings statistics, etc.

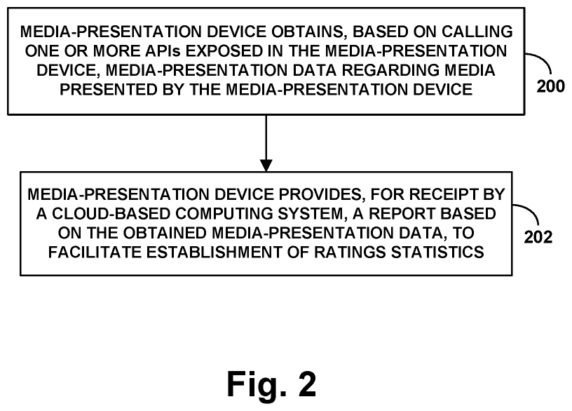

FIG. 2 is a flow chart illustrating a method that could be carried out in accordance with the present disclosure for soft-metering by a media-presentation device. The media-presentation device comprises a media-input interface through which to receive media for presentation by the media-presentation device, and a media-presentation interface through which to present the received media. As shown in FIG. 2, the method then includes, at block 200, the media-presentation device obtaining, based on calling one or more APIs exposed in the media-presentation device, media-presentation data regarding the presented media. Further, at block 202, the method includes the media-presentation device providing, for receipt by a cloud-based computing system, a report based on the obtained media-presentation data, to facilitate establishment of ratings statistics.

Various features described above can be carried out in this context as well, and vice versa.

For instance, the media-presentation data could include data such as identification of the presented media, identification of a channel of the presented media, identification of a source of the presented media, audio volume of presentation of the media, and/or user identification information indicating one or more individuals exposed to the presented media.

Further, the media-presentation device could be controllable by an external remote control, and the one or more APIs exposed in the media-presentation device could include a remote-control API configured to enable the media-presentation device to provide the external remote control with information about the presented media, and the act of obtaining the media-presentation data based on calling the one or more APIs exposed in the media-presentation device could involve calling the remote-control API to obtain, as at least a portion of the media-presentation data, the information about the presented media.

As another example, the one or more APIs exposed in the media-presentation device could include an operating system API configured to support user interaction through the media-presentation interface, and the act of obtaining the media-presentation data based on calling the one or more APIs exposed in the media-presentation device could involve obtaining, as at least part of the media-presentation data, the user identification information by calling the operating system API to cause the media-presentation device (i) to present through the media-output interface a prompt requesting user input indicating who is exposed to the presented media and (ii) to receive in response to the presented prompt the user input indicating who is exposed to the presented media.

As still another example, the one or more APIs exposed in the media-presentation device could include an operating system API configured to provide information indicating which of various OTT applications installed on the media-presentation device is currently running and providing content for presentation by the media-presentation device, and the act of obtaining the media-presentation data based on calling one or more APIs exposed in the media-presentation device could involve calling the operating system API to obtain, as at least part of the media-presentation data, an indication of which of the OTT applications, if any, is currently running and providing content for presentation by the media-presentation device.

As yet another example, the media-input interface could include multiple media-input sources, the one or more APIs exposed in the media-presentation device could include an operating system API configured to provide an identification of which media-input source is currently in use, and the act of obtaining the media-presentation data based on calling the one or more APIs exposed in the media-presentation device could involve calling the operating system API to obtain, as at least part of the media-presentation data, an indication of which media-input source is currently in use as a source of the presented media.

Still further, as yet another example, the one or more APIs exposed in the media-presentation device could include an operating system API configured to provide closed-caption text for presentation with the media, and the act of obtaining the media-presentation data based on calling the one or more APIs exposed in the media-presentation device could involve calling the operating system API to obtain, as at least part of the media-presentation data, the closed-caption text.

As additionally noted above, the present disclosure also contemplates at least one non-transitory computer-readable medium that is encoded with, stores, or otherwise embodies program instructions executable by a processor to carry out various operations as described above.

For instance, a non-transitory computer-readable medium could embody instructions executable by a processor of a media-presentation device to carry out soft-meter operations. The media-presentation device could include a media-input interface through which to receive media for presentation by the media-presentation device, and a media-presentation interface through which to present the received media. And the soft-meter operations could include (i) obtaining, based on calling one or more APIs exposed in the media-presentation device, media-presentation data regarding the presented media and (ii) providing for receipt by a cloud-based computing system a report based on the obtained media-presentation data, to facilitate establishment of ratings statistics.

Exemplary embodiments have been described above. Those skilled in the art will understand, however, that changes and modifications may be made to these embodiments without departing from the true scope and spirit of the invention.

What is claimed is:

1. A media-presentation device configured with soft-meter functionality, the media-presentation device comprising:
a media-input interface through which to receive media for presentation by the media-presentation device;
a media-presentation interface through which to present the received media;
a processor;
non-transitory data storage; and
a meter application including program instructions stored in the non-transitory data storage and executable by the processor to carry out soft-meter operations including (i) obtaining, based on calling one or more application-programming interfaces (APIs) exposed in the media-presentation device, media-presentation data regarding the presented media and (ii) providing for receipt by a cloud-based computing system a report based on the obtained media-presentation data, to facilitate establishment of ratings statistics.

2. The media-presentation device of claim 1, wherein the media-presentation data comprises data selected from the group consisting of identification of the presented media, identification of a channel of the presented media, identification of a source of the presented media, audio volume of presentation of the media, and user identification information indicating one or more individuals exposed to the presented media.

3. The media-presentation device of claim 2, wherein the media-presentation device is controllable by an external remote control, and wherein the one or more APIs exposed in the media-presentation device comprises a remote-control API configured to enable the media-presentation device to provide the external remote control with information about the presented media,
wherein obtaining the media-presentation data based on calling the one or more APIs exposed in the media-presentation device comprises calling the remote-control API to obtain, as at least a portion of the media-presentation data, the information about the presented media.

4. The media-presentation device of claim 2, wherein the one or more APIs exposed in the media-presentation device comprises an operating system API configured to support user interaction through the media-presentation interface,
wherein obtaining the media-presentation data based on calling the one or more APIs exposed in the media-presentation device comprises obtaining, as at least part of the media-presentation data, the user identification information by calling the operating system API to cause the media-presentation device (i) to present through the media-output interface a prompt requesting user input indicating who is exposed to the presented media and (ii) to receive in response to the presented prompt the user input indicating who is exposed to the presented media.

5. The media-presentation device of claim 2, wherein the one or more APIs exposed in the media-presentation device comprises an operating system API configured to provide information indicating which of various over-the-top (OTT) applications installed on the media- presentation device is currently running and providing content for presentation by the media-presentation device,
wherein obtaining the media-presentation data based on calling one or more APIs exposed in the media-presentation device comprises calling the operating system API to obtain, as at least part of the media-presentation data, an indication of which of the OTT applications, if any, is currently running and providing content for presentation by the media-presentation device.

6. The media-presentation device of claim 2, wherein the media-input interface comprises a plurality of media-input sources, and wherein the one or more APIs exposed in the media-presentation device comprises an operating system API configured to provide an identification of which media-input source is currently in use,
wherein obtaining the media-presentation data based on calling the one or more APIs exposed in the media-presentation device comprises calling the operating system API to obtain, as at least part of the media-presentation data, an indication of which media-input source is currently in use as a source of the presented media.

7. The media-presentation device of claim 2, wherein the one or more APIs exposed in the media-presentation device comprises an operating system API configured to provide closed-caption text for presentation with the media,
wherein obtaining the media-presentation data based on calling the one or more APIs exposed in the media-presentation device comprises calling the operating system API to obtain, as at least part of the media-presentation data, the closed-caption text.

8. The media-presentation device of claim 2, wherein the one or more APIs exposed in the media-presentation device comprises an operating system API configured to provide information about audio-output volume level of the media-presentation device,
wherein obtaining the media-presentation data based on calling the one or more APIs exposed in the media-presentation device comprises calling the operating system API to obtain, as at least part of the media-presentation data, the information about the audio-output volume level of the media-presentation device.

9. The media-presentation device of claim 8, wherein the information about the audio-output volume level of the media-presentation device comprises information about the media-presentation device being in a mute state in which the audio-output volume level is zero.

10. The media-presentation device of claim 1, wherein the one or more APIs exposed in the media-presentation device comprises a media-access API configured to provide access to the presented media,
wherein obtaining the media-presentation data based on calling the one or more APIs exposed in the media-presentation device comprises (a) calling the media-access API to obtain audio of the presented media and (b) establishing based on the obtained audio, as at least part of the media presentation data, audio signature data representing the presented media.

11. The media-presentation device of claim 10, further comprising a local data interface, wherein a microphone-device coupled with the local data interface receives acoustic audio output from a speaker of the media-presentation device and provides to the local data interface a digital representation of the received acoustic audio, and wherein obtaining the audio of the presented media comprises obtaining the digital representation of the received acoustic audio.

12. The media-presentation device of claim 1, wherein the media-presentation device is connectable with a local area network (LAN), and wherein the meter application is further executable by the processor (a) to broadcast on the LAN a discovery request seeking identification of one or more media-monitoring devices present on the LAN, (b) to obtain, in response to the broadcast, the identification of the one or more media-monitoring devices present on the LAN, and (c) to report for receipt by the cloud-based computing system the obtained identification of the one or more media-monitoring devices present on the LAN.

13. A method for soft-metering by a media-presentation device, wherein the media-presentation device comprises a media-input interface through which to receive media for presentation by the media-presentation device, and a media-presentation interface through which to present the received media, the method comprising:
obtaining, by the media-presentation device, based on calling one or more application-programming interfaces (APIs) exposed in the media-presentation device, media-presentation data regarding the presented media; and
providing, by the media-presentation device, for receipt by a cloud-based computing system, a report based on the obtained media-presentation data, to facilitate establishment of ratings statistics.

14. The method of claim 13, wherein the media-presentation data comprises data selected from the group consisting of identification of the presented media, identification of a channel of the presented media, identification of a source of the presented media, audio volume of presentation of the media, and user identification information indicating one or more individuals exposed to the presented media.

15. The method of claim 14, wherein the media-presentation device is controllable by an external remote control, and wherein the one or more APIs exposed in the media-presentation device comprises a remote-control API configured to enable the media-presentation device to provide the external remote control with information about the presented media,
wherein obtaining the media-presentation data based on calling the one or more APIs exposed in the media-presentation device comprises calling the remote-control API to obtain, as at least a portion of the media-presentation data, the information about the presented media.

16. The method of claim 14, wherein the one or more APIs exposed in the media-presentation device comprises an operating system API configured to support user interaction through the media-presentation interface,
wherein obtaining the media-presentation data based on calling the one or more APIs exposed in the media-presentation device comprises obtaining, as at least part of the media-presentation data, the user identification information by calling the operating system API to cause the media-presentation device (i) to present through the media-output interface a prompt requesting user input indicating who is exposed to the presented media and (ii) to receive in response to the presented prompt the user input indicating who is exposed to the presented media.

17. The method of claim 14, wherein the one or more APIs exposed in the media-presentation device comprises an operating system API configured to provide information indicating which of various over-the-top (OTT) applications installed on the media-presentation device is currently running and providing content for presentation by the media-presentation device,
wherein obtaining the media-presentation data based on calling one or more APIs exposed in the media-presentation device comprises calling the operating system API to obtain, as at least part of the media-presentation data, an indication of which of the OTT applications, if any, is currently running and providing content for presentation by the media-presentation device.

18. The method of claim 14, wherein the media-input interface comprises a plurality of media-input sources, and wherein the one or more APIs exposed in the media-presentation device comprises an operating system API configured to provide an identification of which media-input source is currently in use,
wherein obtaining the media-presentation data based on calling the one or more APIs exposed in the media-presentation device comprises calling the operating system API to obtain, as at least part of the media-presentation data, an indication of which media-input source is currently in use as a source of the presented media.

19. The method of claim 14, wherein the one or more APIs exposed in the media-presentation device comprises an operating system API configured to provide closed-caption text for presentation with the media,
wherein obtaining the media-presentation data based on calling the one or more APIs exposed in the media-presentation device comprises calling the operating system API to obtain, as at least part of the media-presentation data, the closed-caption text.

20. A non-transitory computer-readable medium embodying a meter application defining program instructions executable by a processor of a media-presentation device to carry out soft-meter operations, wherein the media-presentation device comprises a media-input interface through which to receive media for presentation by the media-presentation device, and a media-presentation interface through which to present the received media, the soft-meter operations comprising:
obtaining, based on calling one or more application-programming interfaces (APIs) exposed in the media-presentation device, media-presentation data regarding the presented media; and
providing for receipt by a cloud-based computing system a report based on the obtained media-presentation data, to facilitate establishment of ratings statistics.
